(19) United States
(12) Patent Application Publication
(10) Pub. No.: US 2010/0171851 A1
(43) Pub. Date: Jul. 8, 2010

(54) Pan/tilt method and apparatus for camera

(75) Inventors: Je-Han Yoon, Seongnam-si (KR); Kwang-Choon Kim, Suwon-si (KR); Young-Hee Park, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/655,728

(22) Filed: Jan. 6, 2010

(30) Foreign Application Priority Data
Jan. 6, 2009 (KR) 10-2009-0000715

(51) Int. Cl. H04N 5/262; H04N 5/228

(52) U.S. Cl. 348/240.99; 348/222.1; 348/E05.031; 348/E05.055

(57) ABSTRACT

A camera pan/tilt method includes receiving an input pan/tilt command. The method also includes determining whether the angle to be moved according to the input pan/tilt command is larger than the minimum angle for allowing pan/tilt to be executed by a hardware pan/tilt method. A hardware pan/tilt is executed according to the input pan/tilt command if it is determined that the angle to be moved according to the input pan/tilt command is larger than the minimum angle for allowing pan/tilt to be executed by the hardware pan/tilt method. A digital pan/tilt is executed according to the input pan/tilt command if it is determined that the angle to be moved according to the input pan/tilt command is not larger than the minimum angle for allowing pan/tilt to be executed by the hardware pan/tilt method.

### CROSS-REFERENCE TO RELATED APPLICATION(S) AND CLAIM OF PRIORITY

The present application is related to and claims the priority under 35 U.S.C. §119(a) of an application entitled “Pan/Tilt Method And Apparatus For Camera” filed in the Korean Industrial Property Office on Jan. 6, 2009 and assigned Serial No. 10-2009-0000715, the contents of which are hereby incorporated by reference.

### TECHNICAL FIELD OF THE INVENTION

The present invention relates to a pan/tilt method and apparatus for a camera, and more particularly to a hardware pan/tilt and digital pan/tilt combined pan/tilt method and apparatus for a camera.

### BACKGROUND OF THE INVENTION

When photographing an object with a camera, it is possible to move the camera vertically and horizontally so as to express the height and width of the object. Here, moving the camera horizontally is called “pan,” and moving the camera vertically is called “tilt.”

Among pan/tilt methods employed for a conventional camera, a hardware pan/tilt method, which is executed by driving a hardware, employs a technology for directly adjusting the direction of the camera vertically or horizontally with a motor, and a digital pan/tilt method, which employs a software, obtains a large photographed image (for example, having a size of 640 pixels×480 pixels) which is larger than a required photographed image (for example, having a size of 320 pixels×240 pixels), and then cuts an image in a desired region from the large photographed image, thereby using an image of a desired size. The digital pan/tilt method has an advantage in that it is capable of implementing a function similar to that of the hardware pan/tilt method, even if there is not provided a hardware drive for executing pan/tilt, such as a motor.

The features of the digital pan/tilt method and the hardware pan/tilt method may be compared as indicated in Table 1 below.

TABLE 1

| | Digital Pan/Tilt | Hardware Pan/Tilt |
|---|---|---|
| Advantage | Quick reaction | Wide pan/tilt range |
| | Easy control of | |
| | velocity | |
| Disadvantage | Narrow pan/tilt | Relatively slow initial |
| | range | reaction |
| | | Low initial velocity |
| | | (requiring acceleration) |
| | | Trembling when slowly |
| | | moving |

As indicated in Table 1, the hardware pan/tilt method produces a delay due to the operating characteristic of the motor, and is limited in terms of operating velocity. In particular, when a stop command is rendered during the pan/tilt operation, the hardware for pan/tilt should slowly stop through deceleration. As a result, it is impossible to correctly stop at a desired angle at once.

FIG. 1 illustrates a graph showing velocity variation in terms of time for a conventional hardware pan/tilt operation, and FIG. 2 illustrates a graph showing angle variation in terms of time for the conventional hardware pan/tilt operation.

Referring to FIGS. 1 and 2, if deceleration for hardware pan/tilt is started after a stop command is rendered, the camera cannot stop at a desired stop position at once due to the operating characteristic of a hardware, such as a motor. Rather, the camera gradually converges at the desired position while repeatedly moving back and forth in relation to the desired position, and finally stops at the desired position. Thus, a delay occurs until the camera practically stops after the stop command is rendered.

The digital pan/tilt method may provide smooth movement unlike the movement provided by the hardware pan/tilt method. However, the movable range of pan/tilt is limited. In addition, since the conventional digital pan/tilt method merely cut an image in a desired area so as to adjust the size of the image, the image is different from a resultant image obtained by using the pan/tilt method which practically moves the position of the camera. Such a difference may cause a combined image to be shown unnaturally when the resultant images obtained through the digital and hardware pan/tilt methods are combined with each other.

### SUMMARY OF THE INVENTION

To address the above-discussed deficiencies of the prior art, it is a primary object to provide a hardware pan/tilt and digital pan/tilt combined pan/tilt method and apparatus for a camera which can complement disadvantages of a hardware pan/tilt method executed by driving a hardware and a digital pan/tilt method employing a software.

In accordance with an aspect of the present invention, there is provided a camera pan/tilt method including the steps of: receiving an input pan/tilt command; determining whether the angle to be moved according to the input pan/tilt command is larger than the minimum angle for allowing pan/tilt to be executed by a hardware pan/tilt method; executing hardware pan/tilt according to the input pan/tilt command if it is determined that the angle to be moved according to the input pan/tilt command is larger than the minimum angle for allowing pan/tilt to be executed by the hardware pan/tilt method; and executing digital pan/tilt according to the input pan/tilt command if it is determined that the angle to be moved according to the input pan/tilt command is not larger than the minimum angle for allowing pan/tilt to be executed by the hardware pan/tilt method.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a graph showing velocity variation in terms of time for a conventional hardware pan/tilt operation;

FIG. 2 illustrates a graph showing angle variation in terms of time for the conventional hardware pan/tilt operation;

FIG. 3 illustrates a pan/tilt apparatus according to an embodiment of the present invention;

FIG. 4 illustrates a pan/tilt operation according to an embodiment of the present invention;

FIG. 5 exemplifies a case in which a digital pan/tilt area departs an entire image at the time of executing a pan/tilt operation according to an embodiment;

FIG. 6A through 6C illustrate graphs showing angle variation in terms of time for hardware pan/tilt, digital pan/tilt, and final pan/tilt operations when executing pan/tilt according to an embodiment of the present invention; and

FIG. 7 shows a focus and an image capture surface of a camera at the time of executing hardware pan/tilt and digital pan/tilt.

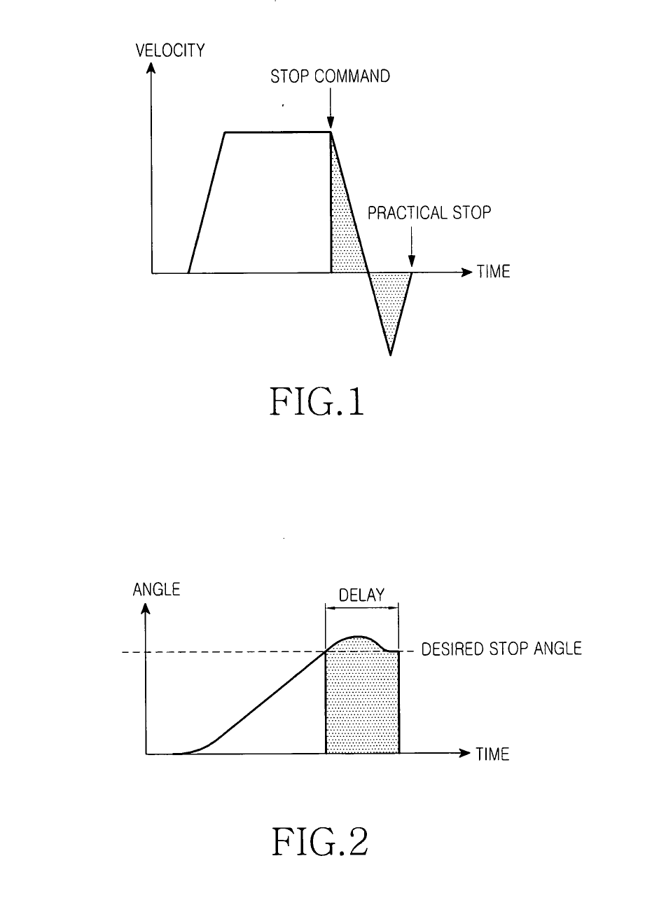

### DETAILED DESCRIPTION OF THE INVENTION

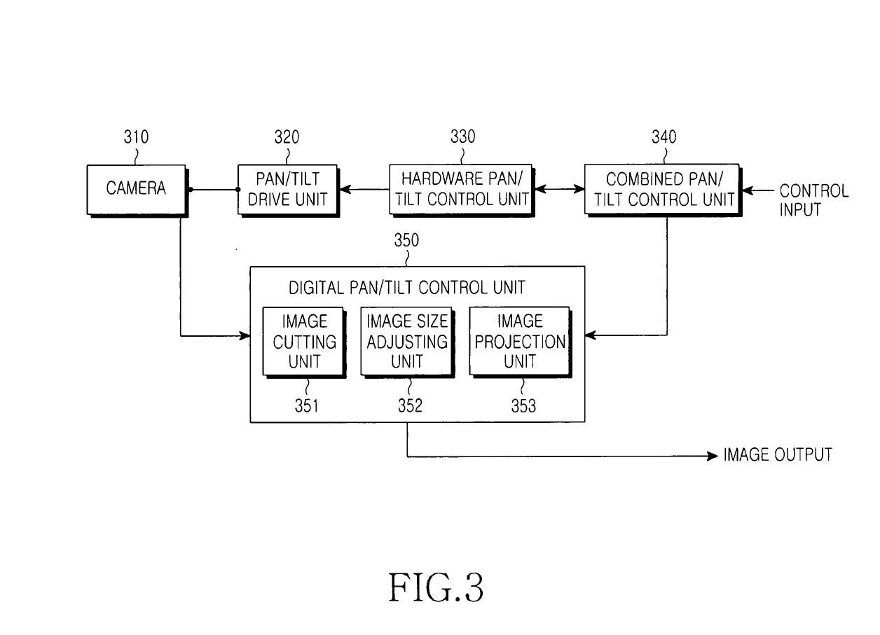

FIGS. 3 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system. Hereinafter, exemplary embodiments of the present invention will be described with reference to the accompanying drawings. In the following description, the same elements will be designated by the same reference numerals although they are shown in different drawings. Further, various specific definitions found in the following description, such as specific values of packet identifications, contents of displayed information, etc., are provided only to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear.

The present invention proposes a hardware method and digital method combined camera pan/tilt method so as to complement the disadvantages of a conventional hardware pan/tilt method executed by driving a hardware and a digital pan/tilt method employing a software.

For this purpose, the present invention employs a digital pan/tilt method so as to correct a delay and error caused by a hardware device when the pan/tilt operation is executed through a hardware pan/tilt method, and executes pan/tilt using the digital pan/tilt method if the pan/tilt angle is too small to be executed through the hardware pan/tilt, and executes hardware tilt if it is impossible to execute digital pan/tilt since a desired image obtained through the digital pan/tilt operation departs from an entire image.

FIG. 3 illustrates a pan/tilt apparatus according to an embodiment of the present invention.

Referring to FIG. 3, the pan/tilt apparatus includes a camera 310, a pan/tilt drive unit 320, a hardware pan/tilt control unit 330, a combined pan/tilt control unit 340, and a digital pan/tilt control unit 350.

The camera 310 includes an image sensor and a lens, and is physically connected with the pan/tilt drive unit 320. In addition, the camera 310 photographs an object, converts image information received through the lens into an electric signal, and transmits the electric signal to the digital pan/tilt control unit 350.

The pan/tilt drive unit 320 is physically connected with the camera 310, and moves the camera 310 vertically or horizontally according to a control signal received from the hardware pan/tilt control unit 330. In addition, the pan/tilt drive unit 320 may be implemented so that it can perform the optical zooming operation of the camera.

The hardware pan/tilt control unit 330 produces a control signal for controlling the pan/tilt drive unit 320. According to a characteristic of the pan/tilt drive unit 320, the hardware pan/tilt control unit 330 may execute deceleration/acceleration and velocity control. In addition, the hardware pan/tilt unit 330 predicts the position of the camera according to the control of the deceleration/acceleration, and periodically transmits the position to the combined pan/tilt control unit 340.

The combined pan/tilt control unit 340 receives and converts control input and feedback information from the hardware pan/tilt control unit 330 into a hardware pan/tilt control signal and a software pan/tilt control signal, respectively. In other words, the combined pan/tilt control unit 340 determines which one will be executed among hardware pan/tilt and software pan/tilt. More specifically, the combined pan/tilt control unit 340 receives an input of pan/tilt command, and determines whether an angle to be moved according to the input pan/tilt command is larger than the minimum angle for allowing pan/tilt to be executed through the hardware pan/tilt method. In this regard, the combined pan/tilt control unit 340 controls in the following manner: if it is determined that the angle to be moved according to the input pan/tilt command is larger than the minimum angle for allowing the pan/tilt to be executed through the hardware pan/tilt method, the combined pan/tilt control unit 340 renders the hardware pan/tilt to be executed according to the input pan/tilt command; and if it is determined that the angle to be moved according to the input pan/tilt command is not larger than the minimum angle for allowing the pan/tilt to be executed through the hardware pan/tilt method, the combined pan/tilt control unit 340 renders the digital pan/tilt to be executed according to the input pan/tilt command.

When the hardware pan/tilt is executed, the combined pan/tilt control unit 340 calculates an error produced due to the hardware pan/tilt, and renders the digital pan/tilt to be executed by an angle to correct the calculated error. In addition, when the digital pan/tilt is executed, the combined pan/tilt control unit calculates an area for obtaining a partial image to execute the digital pan/tilt. If the partial image to execute the digital pan/tilt is not offset from an entire image stored for the digital pan/tilt, the combined pan/tilt control unit 340 renders the digital pan/tilt to be executed, and if the partial image to execute the digital pan/tilt departs from the entire image stored for the digital pan/tilt, the combined pan/tilt control unit 340 renders the hardware pan/tilt to be executed by an area required for the digital pan/tilt.

In addition, the combined pan/tilt control unit 340 projects the image obtained through the digital pan/tilt onto the image obtained through the hardware pan/tilt.

The digital pan/tilt control unit 350 processes image information received from the camera so as to give a pan/tilt effect. The digital pan/tilt control unit 350 includes a image cutting unit 351 that extracts an area calculated by a pan/tilt command, an image size that adjusts unit 354 for adjusting the size of the image, and an image projection unit 353 executes image projection so as to make the image obtained through the digital pan/tilt similar to that obtained through the hardware pan/tilt.

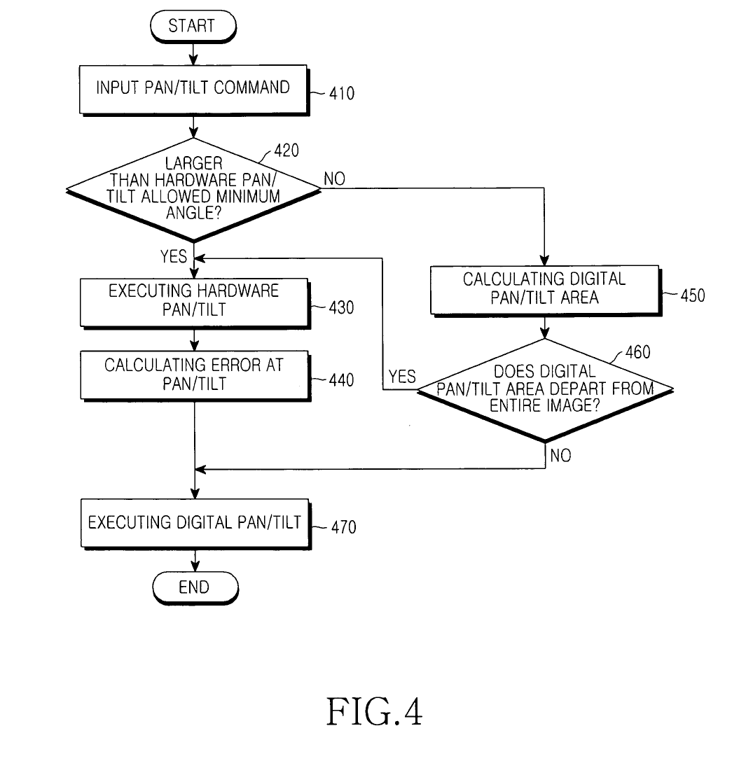

FIG. 4 illustrates a pan/tilt operation according to an embodiment of the present invention.

Referring to FIG. 4, at first, the pan/tilt apparatus according to the present invention receives a pan/tilt command input by a user or a specific input in step 410.

Next, in step 420, the combined pan/tilt control unit 340 determines whether a moving angle (a relative or absolute angle) in the input pan/tilt command is larger than the minimum angle for allowing pan/tilt to be executed through the hardware pan/tilt method.

In the step 420, if it is determined that the angle in the input pan/tilt is larger than the minimum angle for allowing pan/tilt to be executed through the hardware pan/tilt method, the process proceeds to step 430. In the step 430, the input pan/tilt command is transmitted to the hardware pan/tilt control unit 330, and the hardware pan/tilt control unit 330 produces a control signal for controlling the pan/tilt control unit 330 according to the input pan/tilt command and transmits the control signal to the pan/tilt drive unit 320. The pan/tilt drive unit 320 controls the camera 310 according to the received control signal so that the hardware pan/tilt is executed.

In step 440, an error occurring when the hardware pan/tilt is executed is calculated. The error may be calculated on the basis of angular position predicting information periodically provided from the hardware pan/tilt control unit 330, or merely using the minimum operation unit of the hardware pan/tilt. If it is possible to use the predicting information, the error may be calculated in comparison to ideal movement.

Next, in step 470, the digital pan/tilt is executed by an angle for correcting the error calculated in the step 440.

In the step 420, if it is determined that the angle in the input pan/tilt is not larger than the minimum angle for allowing pan/tilt to be executed through the hardware pan/tilt method, the process proceeds to step 450. In the step 450 an area for obtaining a desired partial image is calculated so as to execute the digital pan/tilt.

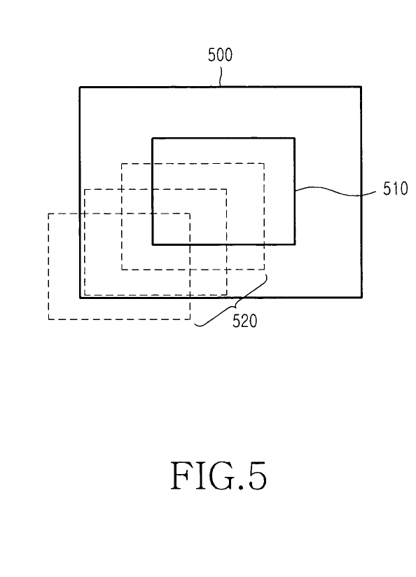

FIG. 5 exemplifies a case in which a digital pan/tilt area departs from an entire image at the time of performing a pan/tilt operation.

Referring to FIG. 5, in step 450, a partial image 510 to be obtained through digital pan/tilt in the entire image 500, which has been obtained from the camera and stored for digital pan/tilt, is calculated. At this time, if pan/tilt commands are continuously input in the same direction, the digital pan/tilt is executed in the entire image according to the input commands (step 520). Then, a situation may arise in which the digital pan/tilt operation cannot be executed any more as shown in FIG. 5.

In order to avoid such a situation, in step 460, it is determined whether the area calculated for the digital pan/tilt departs from the entire image to one direction to such an extent that the digital pan/tilt cannot be executed any more. If it is determined that the digital pan/tilt cannot be executed any more in the step 460, the process proceeds to the step 430 where the hardware pan/tilt is executed by an area insufficient for executing the digital pan/tilt, which has been determined in the step 460. Next, the process proceeds to the step 440. Since the operations to be performed in the step 440 are equal to those described above, the operations will not be described any more.

If it is determined that the digital pan/tilt can be executed in the step 460, the process proceeds to step 470 so that the digital pan/tilt is continuously executed.

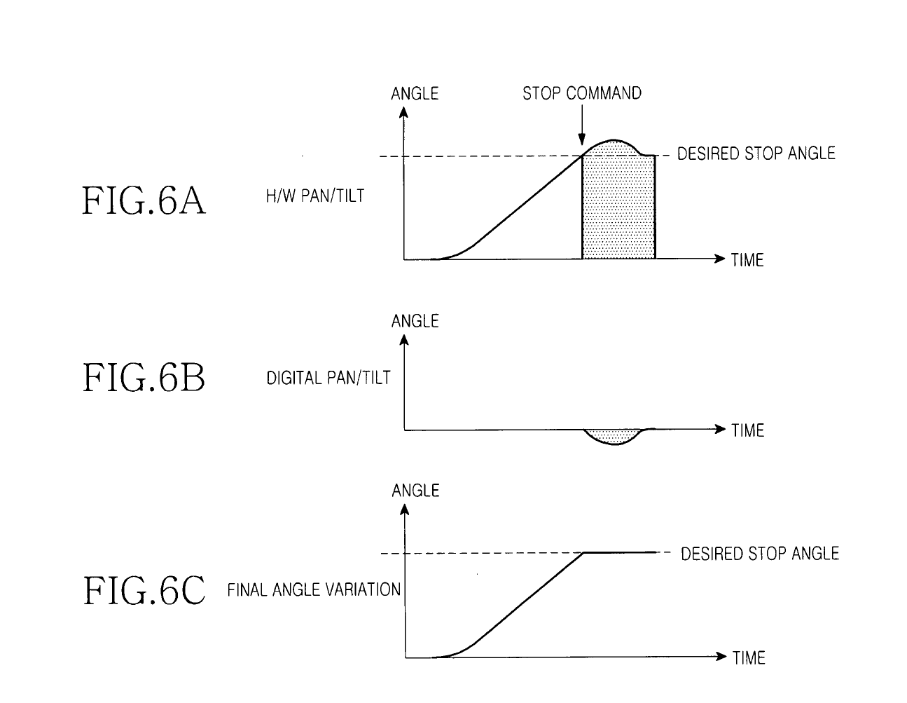

The angle variation in terms of time when executing a hardware pan/tilt and digital pan/tilt combined pan/tilt operation according to an embodiment of the present invention will be discussed with reference to FIG. 6A through 6C. FIG. 6A to 6C illustrate graphs showing angle variation in terms of time of hardware pan/tilt, digital pan/tilt, and final pan/tilt operations when executing pan/tilt according to an embodiment of the present invention. More specifically, FIG. 6A shows angle variation in terms of time, which is caused by hardware pan/tilt, FIG. 6B shows angle variation in terms of time, which is caused by digital pan/tilt, and FIG. 6C shows angle variation in terms of time, which is caused by the combination of hardware pan/tilt and digital pan/tilt.

It is possible to correct the error occurring when executing hardware pan/tilt as shown in FIG. 6A through digital pan/tilt as shown in FIG. 6B, whereby executing error-free pan/tilt as shown in FIG. 6C.

Through this operation, the present invention can remove the error and delay caused by a sudden command rendered at the time of hardware pan/tilt as shown in FIG. 6C.

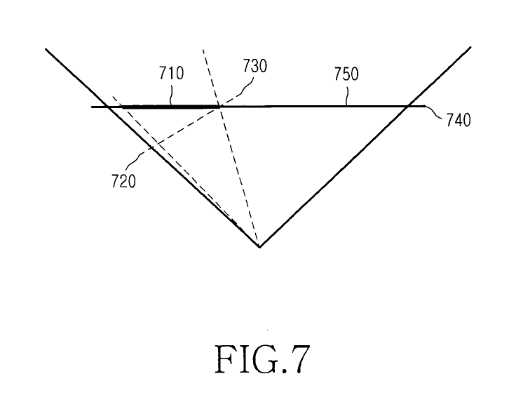

FIG. 7 shows a focus and an image capture surface of a camera at the time of executing hardware pan/tilt and digital pan/tilt.

When it is desired to use the two methods of hardware pan/tilt and digital pan/tilt in combination, another problem required to be solved is the discontinuous change of image. If a camera is moved by the same angle through the hardware pan/tilt and the digital pan/tilt, there will be a difference between the resultant images obtained through the two pan/tilt methods.

Referring to FIG. 7, light introduced into the inside of the camera through the lens is captured on the image capture surface, and the result of converting the light into an electrical signal is outputted from the camera. As a result, in the case of the digital pan/tilt method, an image moved in parallel from the entire image 740 obtained by the camera will be the partial image 710 obtained by executing the digital pan/tilt. Whereas, in the case of the hardware digital pan/tilt, an image 720 is obtained on the image capture surface turned about the focus. Thus, although no problem is caused when only one method is used among the above-mentioned two methods, a feeling may be given that the resultant image rolls when the above-mentioned two methods are used in combination as in the present invention. In order to solve this problem, the image projection unit 353 of the digital pan/tilt control unit 350 projects the image 710 obtained by the digital pan/tilt onto the image 720 obtained by the hardware pan/tilt. As a result, projection is made to a virtual image capture surface; whereby even if the digital pan/tilt is executed, it is possible to obtain an image which is identical to that obtained by executing the hardware pan/tilt.

The present invention can implement pan/tilt which is more natural than a conventional pan/tilt method by combining a digital pan/tilt method and a hardware pan/tilt method, can remove an error occurring at the time of executing hardware pan/tilt, and can quickly react according to a sudden command which is frequently rendered at the time of following a human's face/object using an image or monitoring an image.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A camera pan/tilt method comprising:
receiving an input pan/tilt command;
determining whether the angle to be moved according to the input pan/tilt command is larger than the minimum angle for allowing pan/tilt to be executed by a hardware pan/tilt method;
executing hardware pan/tilt according to the input pan/tilt command if it is determined that the angle to be moved according to the input pan/tilt command is larger than the minimum angle for allowing pan/tilt to be executed by the hardware pan/tilt method; and
executing digital pan/tilt according to the input pan/tilt command if it is determined that the angle to be moved according to the input pan/tilt command is not larger than the minimum angle for allowing pan/tilt to be executed by the hardware pan/tilt method.

2. The method as claimed in claim 1, wherein the step of executing the hardware pan/tilt comprises:
calculating an error occurring at the time of executing the hardware pan/tilt; and
executing digital pan/tilt by an angle for correcting the calculated error.

3. The method as claimed in claim 1, wherein executing the digital pan/tilt comprises:
calculating an area for obtaining a partial image for executing the digital pan/tilt; and
executing the digital pan/tilt if the partial image for executing the digital pan/tilt does not depart from an entire image stored for digital pan/tilt.

4. The method as claimed in claim 3, further comprising executing hardware pan/tilt by an area required for the digital pan/tilt if the partial image for executing the digital pan/tilt departs from an entire image stored for digital pan/tilt.

5. The method as claimed in claim 1, wherein the error occurring at the time of executing the hardware pan/tilt is calculated by using angular position predicting information transmitted from a hardware pan/tilt control unit.

6. The method as claimed in claim 1, wherein the error occurring at the time of executing the hardware pan/tilt is calculated by using the minimum operation unit of the hardware pan/tilt.

7. The method as claimed in claim 1, further comprising projecting an image obtained through the digital pan/tilt onto an image obtained through the hardware pan/tilt.

8. A camera pan/tilt apparatus comprising:
a pan/tilt drive unit configured to execute the hardware pan/tilt of a camera configured to photograph an object; the pan/tilt unit adapted to be physically coupled to the camera;
a hardware pan/tilt control unit configured to produce a control signal adapted to control the pan/tilt drive unit;
a digital pan/tilt control unit configured to execute the digital pan/tilt of the camera; and
a combined pan/tilt control unit configured to receive an input pan/tilt command, and determine whether the angle to be moved according to the input pan/tilt command is larger than the minimum angle for allowing pan/tilt to be executed by a hardware pan/tilt method, wherein the combined pan/tilt control unit further is configured to control the pan/tilt in such a manner that:
hardware pan/tilt is executed according to the input pan/tilt command if it is determined that the angle to be moved according to the input pan/tilt command is larger than the minimum angle for allowing pan/tilt to be executed by the hardware pan/tilt method; and
digital pan/tilt is executed according to the input pan/tilt command if it is determined that the angle to be moved according to the input pan/tilt command is not larger than the minimum angle for allowing pan/tilt to be executed by the hardware pan/tilt method.

9. The apparatus as claimed in claim 8, wherein the hardware pan/tilt control unit is configured to predict the position of the camera according to the control signal, and periodically transmits the position to the combined pan/tilt control unit.

10. The apparatus as claimed in claim 8, wherein the digital pan/tilt control unit comprises:
an image cut unit configured to extract an area calculated by the pan/tilt command;
an image size adjusting unit configured to adjust the size of an image; and
an image projection unit configured to make the image obtained by executing the digital pan/tilt similar to the image obtained by executing the hardware pan/tilt.

11. The apparatus as claimed in claim 8, wherein executing the hardware pan/tilt by the combined pan/tilt control unit comprises calculating an error occurring at the time of executing the hardware pan/tilt, and executing digital pan/tilt by an angle for correcting the calculated error.

12. The apparatus as claimed in claim 8, wherein executing the digital pan/tilt by the combined pan/tilt control unit comprises calculating an area for obtaining a partial image for executing the digital pan/tilt, and executing the digital pan/tilt if the partial image for executing the digital pan/tilt does not depart from an entire image stored for digital pan/tilt.

13. The apparatus as claimed in claim 12, wherein the combined pan/tilt control unit executes the hardware pan/tilt by an area required for the digital pan/tilt if the partial image for executing the digital pan/tilt departs from an entire image stored for digital pan/tilt.

14. The apparatus as claimed in claim 8, wherein the error occurring at the time of executing the hardware pan/tilt is calculated by using angular position predicting information transmitted from a hardware pan/tilt control unit or by using the minimum operation unit of the hardware pan/tilt.

15. The apparatus as claimed in claim 8, wherein the combined pan/tilt control unit projects an image obtained through the digital pan/tilt onto an image obtained through the hardware pan/tilt.

16. A photography system comprising:
a camera configured to photograph an object;
a pan/tilt drive unit configured to execute the hardware pan/tilt of the camera, the pan/tilt unit physically coupled to the camera;
a hardware pan/tilt control unit configured to produce a control signal adapted to control the pan/tilt drive unit;
a digital pan/tilt control unit configured to execute the digital pan/tilt of the camera; and
a combined pan/tilt control unit configured to receive an input pan/tilt command, and determine whether the angle to be moved according to the input pan/tilt command is larger than the minimum angle for allowing pan/tilt to be executed by a hardware pan/tilt method.

17. The system of claim 16, wherein the combined pan/tilt control unit further is configured to control the pan/tilt in such a manner that:
hardware pan/tilt is executed according to the input pan/tilt command if it is determined that the angle to be moved according to the input pan/tilt command is larger than the minimum angle for allowing pan/tilt to be executed by the hardware pan/tilt method; and
digital pan/tilt is executed according to the input pan/tilt command if it is determined that the angle to be moved according to the input pan/tilt command is not larger than the minimum angle for allowing pan/tilt to be executed by the hardware pan/tilt method.

18. The system as claimed in claim 16, wherein the hardware pan/tilt control unit is configured to predict the position of the camera according to the control signal, and periodically transmits the position to the combined pan/tilt control unit.

19. The system as claimed in claim 16, wherein the digital pan/tilt control unit comprises:
an image cut unit configured to extract an area calculated by the pan/tilt command;
an image size adjusting unit configured to adjust the size of an image; and
an image projection unit configured to make the image obtained by executing the digital pan/tilt similar to the image obtained by executing the hardware pan/tilt.

20. The system as claimed in claim 16, wherein executing the hardware pan/tilt by the combined pan/tilt control unit comprises calculating an error occurring at the time of executing the hardware pan/tilt, and executing digital pan/tilt by an angle for correcting the calculated error.

21. The system as claimed in claim 16, wherein executing the digital pan/tilt by the combined pan/tilt control unit comprises calculating an area for obtaining a partial image for executing the digital pan/tilt, and executing the digital pan/tilt if the partial image for executing the digital pan/tilt does not depart from an entire image stored for digital pan/tilt.

22. The system as claimed in claim 21, wherein the combined pan/tilt control unit executes the hardware pan/tilt by an area required for the digital pan/tilt if the partial image for executing the digital pan/tilt departs from an entire image stored for digital pan/tilt.

23. The system as claimed in claim 16, wherein the error occurring at the time of executing the hardware pan/tilt is calculated by using angular position predicting information transmitted from a hardware pan/tilt control unit or by using the minimum operation unit of the hardware pan/tilt.

24. The system as claimed in claim 16, wherein the combined pan/tilt control unit projects an image obtained through the digital pan/tilt onto an image obtained through the hardware pan/tilt.
